(19) United States
(12) Patent Application Publication
(10) Pub. No.: US 2024/0294700 A1
(43) Pub. Date: Sep. 5, 2024

(54) URETHANE COMPOUNDS FOR FINISHING TEXTILE SHEET MATERIALS IN A FLUORINE-FREE MANNER

(71) Applicant: Evonik Operations GmbH, Essen (DE)

(72) Inventors: Ruben Benedikt Richrath, Recklinghausen (DE); Gabriele Platte, Castrop-Rauxel (DE); Nicole Pfeiffer, Froendenberg (DE); Stefan Bergfried, Essen (DE); Verena Dahl, Bergisch Gladbach (DE); Kathrin Stremmer, Essen (DE); Sarah Radloff, Bochum (DE); Caren Röben, Essen (DE); Nino Bagus, Essen (DE); Jan Marian von Hof, Bochum (DE)

(73) Assignee: Evonik Operations GmbH, Essen (DE)

(21) Appl. No.: 18/569,296

(22) PCT Filed: Jun. 9, 2022
(86) PCT No.: PCT/EP2022/065625

§ 371 Date: Dec. 12, 2023

(30) Foreign Application Priority Data
Jun. 17, 2021 (EP) 21179942.4

(51) Int. Cl. C08G 18/79; C08G 18/10; C08G 18/48; C08G 18/61; D06M 15/653

(52) U.S. Cl. CPC C08G 18/792; C08G 18/10; C08G 18/4887; C08G 18/61; D06M 15/653; D06M 2200/11; D06M 2200/12

(57) ABSTRACT

A urethane compound contains at least one polyglycerol structural unit. A method for producing the urethane compound is developed. A method for the impregnation of textile fabrics using the urethane compound is also developed, and the textile fabrics thereof are made.

The present invention relates to active substances for the fluorine-free finishing of textile fabrics.

Numerous active substances for finishing textiles are known. Among these, the class of the perfluorinated and polyfluorinated alkyl compounds (perfluoroalkyl and polyfluoroalkyl substances, PFASs) are of particular importance since they can impart particularly good water repellency and additionally oil repellency on the textiles. For this reason, PFASs are frequently used for finishing textiles for example for sports and leisure wear, gardening gear, and also for technical and military applications. Further fields of use include, inter alia, hydrophobic membranes and paper products. A disadvantage with these fluorinated finishes is that they result in very long-lived PFASs entering the environment. These persistent compounds accumulate in organisms and can lead to considerable harm to the environment and humans. For example, perfluorooctanoic acid (PFOA), which enters the environment via textile finishes, is associated with liver-damaging, reprotoxic and carcinogenic properties. A further disadvantage of PFAS-containing finishes is additionally that the hydrophobizing action diminishes after a certain amount of time and must be reactivated via a heat treatment. The mentioned disadvantages of PFAS-based compositions has led to an urgent need for PFAS-free active substances.

As an alternative to fluorine-containing finishes, finishes based on simple waxes are known. These waxes are essentially composed of long alkyl chains. They have the disadvantage that they impart a waxy texture on the textile, the feel (also referred to as “touch”) of which is objected to by many potential users. In addition, such comparatively simply constructed compounds are readily leached out of the textile during washing with commercial detergents, which results in a loss of hydrophobizing action.

Improvements can be achieved by crosslinking waxy components with long alkyl chains together with melamine derivatives to form higher molecular weight polymers. For example, DE 1017133 B describes hydrophobizing agents which are to be produced by mixing a condensation product formed from hexamethylolmelamine hexamethyl ether, stearic acid, stearic acid diglyceride (glycerol distearate) and triethanolamine with paraffin. However, the disadvantage with such melamine-based compositions is the high active substance requirement and the hardness that the melamine active substance imparts on the textile.

A further favoured motif for water-repellent finishes is the combination of long alkyl chains with polyurethanes. For instance, WO 2018/146016 A1 describes copolymers comprising or consisting of a component a) having at least one biuret or isocyanurate substructure, a component b) selected from polysiloxanes and polyhydrocarbons, and a component c) which contains a hydrocarbon that differs from component b) and has at least 6 carbon atoms and at most 3 heteroatoms selected from the group N, O, S, wherein component b) is linked via at least two positions with two different or identical components a). These copolymers serve as active substances for the oleophobic and hydrophobic finishing of textiles. Long alkyl chains are disclosed here only as a constituent of component c). Specifically, the copolymers with long alkyl chains that are disclosed are those based on isostearyl alcohol, stearyl alcohol and myristyl alcohol. These alcohols are reacted directly with the isocyanate groups of an isocyanate. The isocyanate groups of the isocyanate are additionally required for the attachment of component b). The copolymer therefore has less than one long alkyl chain per isocyanate group reacted. As a result, the number of and hence the proportion by mass of the alkyl chains in the active substance are very low. However, the hydrophobizing action of finishes based on the active substance from WO 2018/146016 A1 is not optimal The inventors have now found that a relatively high number of and hence a relatively high proportion by mass of relatively long hydrocarbon radicals are preferable for the water repellency.

The combination of long alkyl chains with polyurethanes is also disclosed in WO 2016/049278 A1. This document describes the preparation and use of fluorine-free aqueous compositions for the finishing of textiles, these containing, as hydrophobizing compound, a polyurethane compound which is prepared from polyisocyanates and alkyl-substituted sugar alcohols. Examples of the alkyl-substituted sugar alcohols described are alkyl-substituted citric acid, sorbitan and pentaerythritol compounds. In addition to the sugar alcohols, further hydroxy-functional components which may be used are mono- or polyglycerol compounds which may likewise bear alkyl chains. For instance, it is described that the hydrophobizing compound may contain linkers (linkages) of the formula (IVb) R¹⁵—(OCH₂CH(OR¹⁶)CH₂)₂—OR¹⁷, in which R¹⁵, R¹⁶ and R¹⁷ independently are —H, —C(O)NH—, —R¹⁸ or —C(O)R¹⁸, provided that at least one R¹⁵, R¹⁶ or R¹⁷ is a —C(O)NH—, and in which R¹⁸ independently is a linear or branched alkyl radical having 5 to 29 carbon atoms and z is a number from 1 to 15. Linkages/linkers of the formula (IVb) for which z≥2 and which have at least three R¹⁸ radicals are not described. It is further disclosed that the above-described linkage of formula (IVb) can be obtained by reacting active isocyanate groups with isocyanate-reactive compounds of the formula (VIb) R³—(OCH₂CH(OR³)CH₂)_{z}—OR³, in which R³ is independently selected from —H, —R¹⁸ or —C(O)R¹⁸, where z and R¹⁸ are as defined above and in which the proviso applies that at least one R³ is —H. Specific examples for compounds of the formula (VIb) described are triglycerol monostearate, triglycerol distearate, hexaglycerol monostearate, hexaglycerol distearate, decaglycerol mono(caprylate/caprate), decaglycerol di(caprylate/caprate), decaglycerol, polyglycerol-3 and C₁₈ diglyceride, such as for example glycerol distearate. However, compounds of the formula (VIb) for which z>2 and in which at least three of the R³ radicals are selected from —R¹⁸ or —C(O)R¹⁸, and in which the proviso further applies that at least one R³ is —H, are not disclosed. However, the inventors have now found that the use of polyglycerol esters, where these do not bear at least three C₃-C₃₉ hydrocarbon radicals, in the synthesis of hydrophobic urethane compounds can lead to gelation of the reaction mixture, with the result that further formulation of the reaction product to give a composition suitable for the finishing of textiles is not possible. The inventors have further found that, although compounds of the formula (VIb) for which z=1 and in which two of the three R³ radicals are selected from —R¹⁸ or —C(O)R¹⁸ and the remaining R³ radical is —H, such as for example glycerol distearate, can be formulated into a composition suitable for finishing textiles, the water repellency thereof is not optimal. The inventors have further found that sugar-based urethane compounds have a tendency toward discolouration on heating, similar to caramelization. However, heating is a necessary step in the textile treatment.

Fluorine-free water-repellent active substances based on isocyanates, organopolysiloxanes and glycerol esters having long alkyl chains are additionally disclosed in CN 107059405 A and CN 106049069 A. As glycerol esters, exclusively monoglycerol esters are described, and specifically glycerol monostearate in CN 107059405 A and glycerol monostearate, glycerol distearate, glycerol hexadecanoate and glycerol caprylate in CN 106049069 A. Polyglycerol compounds are accordingly not described. However, as already explained, active substances based on monoglycerol esters, such as for example glycerol distearate, result in relatively low water repellency.

There was therefore still a need for fluorine-free water-repellent active substances that have advantages over the prior art. In particular, these active substances should result in relatively high water repellency and/or be easier to formulate.

Surprisingly, it has been found that this problem is solved by a urethane compound containing at least one structural unit (A), wherein the structural unit (A) is a polyglycerol structural unit having at least three R¹ radicals which are each independently selected from C₃-C₃₉ hydrocarbon radicals optionally containing heteroatoms excluding fluorine atoms.

The present invention therefore firstly provides a urethane compound containing at least one structural unit (A), wherein the structural unit (A) is a polyglycerol structural unit having at least three R¹ radicals which are each independently selected from C₃-C₃₉ hydrocarbon radicals optionally containing heteroatoms excluding fluorine atoms.

The invention further provides a process for preparing one or more of the above-mentioned urethane compounds, wherein first an intermediate having at least one structural unit (A) and at least one structural unit (B), but no structural unit (C), is prepared and then this intermediate is converted to give the urethane compound(s).

The invention also further provides a composition containing one or more of the above-mentioned urethane compounds, optionally obtainable by the above-mentioned process.

The invention also further provides a method for the water-repellent and/or oil-repellent impregnation of textile fabrics using one or more of the above-mentioned urethane compounds, optionally obtainable by the above-mentioned process, or using the above-mentioned composition.

The invention also further provides a textile fabric obtainable by the above-mentioned method for water-repellent and/or oil-repellent impregnation.

Advantageous configurations of subject-matter of the invention can be inferred from the claims, the examples and the description. Furthermore, it is explicitly pointed out that the disclosure relating to the subject-matter of the present invention includes all combinations of individual features of the present or subsequent description of the invention and of the claims. More particularly, embodiments of one subject of the invention are also applicable mutatis mutandis to the embodiments of the other subjects of the invention.

One advantage of the invention is that the active substances according to the invention result in a relatively high water repellency and/or are easier to formulate.

A further advantage of the invention is that the urethane compounds according to the invention are not persistent compounds that can accumulate in organisms and lead to harm to the environment and humans.

Another advantage of the invention is the reduced wastewater pollution both in the preparation of and in the use of active substances.

A further advantage of the invention is that the urethane compounds according to the invention exhibit good mechanical stability on textiles.

Another advantage of the invention is that the textiles finished with the urethane compounds according to the invention have high breathability.

The invention also has the advantage that the textiles finished with the urethane compounds according to the invention, even after multiple washes, have a high effect level without any further thermal treatment.

A further advantage of the invention is therefore also the good washing resistance of the impregnation.

A further advantage of the invention is likewise the good abrasion resistance of the impregnation.

Another advantage of the invention is that the textiles finished accordingly have good haptic properties and offer pleasant wear comfort.

Yet a further advantage of the invention is the versatile applicability both to natural and synthetic fibres.

A further advantage of the invention is therefore also the excellent hydrophobization of various textiles.

Another advantage of the invention is the efficient hydrophobization through the use of comparatively low amounts of active substance, in particular in combination with a booster.

A further advantage of the invention is the good sensory properties of the textiles finished with the active substance.

A further advantage of the invention is that the active substance can be prepared in part from bio-based and/or biodegradable raw materials.

Another advantage of the invention is the good storage stability/shelf life both of the pure active substance and of the aqueous formulation.

A further advantage of the invention is low or even no discolouration of the textiles as a result of the impregnation, even on heating.

Another advantage of the invention is the robust and simple synthesis of the active substance on the basis of a modular synthesis strategy. Thanks to this modular synthesis strategy, it is possible to very easily adapt the active substance in a tailored manner to different applications and to different textile fabrics.

The subjects of the invention and their preferred embodiments are described by way of example below without any intention that the invention be confined to these illustrative embodiments. Where ranges, general formulae or compound classes are specified below, these are intended to include not only the corresponding ranges or groups of compounds that are explicitly mentioned but also all subranges and subgroups of compounds that can be obtained by removing individual values (ranges) or compounds. Each embodiment that can be obtained by a combination of ranges/subranges and/or groups/subgroups falls entirely within the disclosure content of the present invention and is considered to be explicitly, directly and unambiguously disclosed.

Where average values are reported hereinafter, these values are numerical averages unless stated otherwise. Where measured values or material properties are reported hereinafter, unless stated otherwise, these are measured values or material properties measured at 25° C. and preferably at a pressure of 101 325 Pa (standard pressure).

Where numerical ranges in the form of “from X to Y” or “X to Y” are reported hereinafter, where X and Y are the limits of the numerical range, this is equivalent to the statement “from at least X up to and including Y”, unless stated otherwise. Stated ranges thus include the range limits X and Y, unless stated otherwise.

Wherever molecules/molecule fragments have one or more stereocentres or can be differentiated into isomers on account of symmetries or can be differentiated into isomers on account of other effects, for example restricted rotation, all possible isomers are included by the present invention.

The word fragment “poly” encompasses compounds constructed from at least two monomer units.

The urethane compound according to the invention is also referred to as active substance within the context of the present invention.

The following formulae describe compounds or structural units which in turn may be constructed from repeating units, for example repeating fragments, blocks or monomer units, and may have a molar mass distribution. The frequency of these repeating units is indicated by indices. The corresponding indices are the numerical average (number average) over all repeating units, unless stated otherwise. The indices used in the formulae for these units should therefore be regarded as statistical averages (numerical averages), unless stated otherwise. The indices used and also the value ranges of the reported indices are thus understood to be averages of the possible statistical distribution of the structures that are actually present and/or mixtures thereof, unless stated otherwise. The repeating units in the formulae that follow may have any desired distribution. The structures constructed from the repeating units may have a blockwise structure with any number of blocks and any sequence or they may be subject to a randomized distribution; they may also have an alternating structure or else form a gradient along the chain, if there is one; in particular, they can also form any mixed forms in which groups of different distributions may optionally follow one another.

Specific embodiments may result in statistical distributions being restricted as a consequence of the embodiment. For all regions unaffected by the restriction, the statistical distribution is unchanged.

As already explained, the urethane compound according to the invention contains at least one structural unit (A), wherein the structural unit (A) is a polyglycerol structural unit having at least three

R¹ radicals which are each independently selected from C₃-C₃₉ hydrocarbon radicals optionally containing heteroatoms excluding fluorine atoms.

The urethane compound is preferably a polyurethane compound, i.e. a compound having two or more urethane groups.

It is preferable that the structural unit (A) is bonded to the rest of the urethane compound via at least one, preferably one or two, in particular exactly one, urethane group.

It is likewise preferable that at least one of the structural units (A) and preferably all structural units (A) within the urethane compound are monovalent radicals.

It is therefore preferable that at least one of the structural units (A) and preferably all structural units (A) are at terminal positions in the urethane compound.

The structural unit (A) is a polyglycerol structural unit. It is based on a polyglycerol. The polyglycerol structural unit can be understood to be a polyglycerol in which the hydrogen atoms of the hydroxy groups have been partially or completely substituted. A polyglycerol for its part is a compound which is obtainable by reaction of two or more glycerol molecules with elimination of water, i.e. by a condensation reaction of two or more glycerol molecules with elimination of water. In the process, a glycerol molecule becomes a glycerol structural unit in the polyglycerol molecule. The polyglycerol molecule therefore has two or more glycerol structural units. The structural unit (A) may therefore, for example, have 2, 3, 4, 5, 6, 7, 8, 9, 10, 11, 12, 13, 14, 15, 16, 17, 18, 19, 20, etc., glycerol structural units. It is preferable that the structural unit (A) has 2 to 14, preferably 2 to 10, especially 3 to 6, glycerol structural units. It is particularly preferable that the structural unit (A) has three glycerol structural units.

The structural unit (A) has at least three R¹ radicals. It is possible here that the structural unit (A) further has at least one hydroxy group. It is preferable here that the structural unit (A) has more R¹ radicals than hydroxy groups. It is particularly preferable that the structural unit (A) has no hydroxy groups.

It is further preferable that the proportion by mass of the R¹ radicals of all structural units (A), based on the total mass of the urethane compound, is from 10% to 90%, preferably from 20% to 80%, especially from 30% to 70%.

The R¹ radicals may be introduced into glycerol structural units in various ways. For example, by reaction of hydroxy groups of the polyglycerol with an alcohol, a carboxylic acid, an isocyanate, an epoxide, an ester, an anhydride, or another compound which bears at least one group that can react with a hydroxy group. Examples of suitable esters include alkylated ketene dimers (alkyl ketene dimers (AKDs)). Examples of anhydrides that may be chosen include alkenylsuccinic anhydrides. The isocyanate used may for example be stearyl isocyanate. Examples of suitable epoxides include epoxidized plant oils. Examples of carboxylic acids that may be chosen include fatty acids. Examples of suitable alcohols include fatty alcohols. Preferably, R¹ radicals are introduced into glycerol structural units by reaction of polyglycerol with an alcohol R¹OH and/or with a carboxylic acid R¹COOH, especially with a carboxylic acid R¹COOH, with elimination of water.

It is preferable that the structural unit (A) is composed of at least two units [C₃H₅O_{3/2}] and at least four units [O_{1/2}R²], in which R² each independently is selected from the group consisting of Z, H, R¹, C(O)R¹, preferably from the group consisting of Z, H, C(O)R¹, especially from the group consisting of Z and C(O)R¹, in which Z is a covalent bond to the rest of the urethane compound.

Here, [C₃H₅O_{3/2}] is

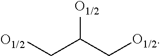

Of course, the proviso also applies here that the structural unit (A) has at least three R¹ radicals.

Here, the structural unit (A) is composed of the units [C₃H₅O_{3/2}] and [O_{1/2}R²] such that each O_{1/2} forms an O together with another O_{1/2.} The O_{1/2} thus only occur in pairs.

It is more preferable that the structural unit (A) is a unit of the general formula (I).

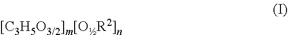

in which
m=2 to 14, preferably 2 to 10, especially 3 to 6, and
n=4 to 30, preferably 4 to 22, especially 4 to 14.

Here, m and n are the number of the corresponding units in a structural unit (A) and/or the number of the corresponding units per structural unit (A), given as a numerical average (arithmetic average) over all structural units (A) (e.g. in the composition according to the invention), preferably the latter, that is to say the number of corresponding units per structural unit (A) given as a numerical average (arithmetic average) over all structural units (A).

If, for example, there are 50 structural units [C₃H₅O_{3/2}]₂[O_{1/2}R²]₄ and 50 structural units [C₃H₅O_{3/2}]₃[O_{1/2}R²]₅, this corresponds as arithmetic average to 100 structural units [C₃H₅O_{3/2}]_{2.5}[O_{1/2}R²]_{4.5}. 20 structural units [C₃H₅O_{3/2}]₂[O_{1/2l R}²]₄ structural units [C₃H₅O_{3/2}]₃[O_{1/2}R²]₅ correspond as arithmetic average to 100 structural units [C₃H₅O_{3/2}]_{2.5}[O_{1/2}R²]_{4.8}.

A structural unit formed from two units [C₃H₅O_{3/2}] and four units [O_{1/2}R²], hence [C₃H₅O_{3/2}]₂[O_{1/2} R²]₄, can for example be one of the following three structures:

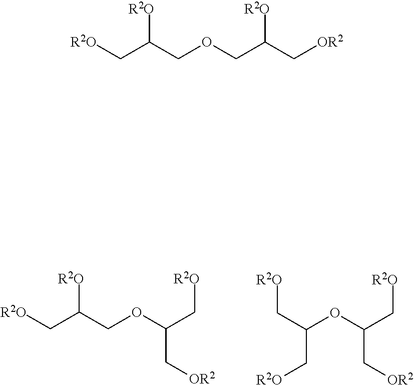

It is further preferable that the structural unit (A) is composed of at least two glycerol structural units, the glycerol structural units being selected from the group consisting of A^{M}=[C₃H₅(OR²)₂O_{1/2}], A^{D}=[C₃H₅(OR²)₁O_{2/2}] and A^{T}=[C₃H₅O_{3/2}], in which R² each independently is selected from the group consisting of Z, H, R¹, C(O)R¹, preferably from the group consisting of Z, H, C(O)R¹, especially from the group consisting of Z and C(O)R¹, in which Z is a covalent bond to the rest of the urethane compound.

It is further preferable that exactly one R² of the structural unit (A) is Z and all other R² are selected from the group consisting of H, R¹, C(O)R¹, preferably from the group consisting of R¹, C(O)R¹, and especially are C(O)R¹.

It is particularly preferable that exactly one R² of the structural unit (A) is Z and all other R² are C(O)R¹, in which all R¹ each independently are selected from C₄-C₃₉, preferably C₇-C₂₉, especially C₁₅-C₂₃ hydrocarbon radicals.

The glycerol structural units A^{M}, A^{D} and A^{T} have the following meaning here:
A^{M}, or [C₃H₅(OR²)₂O_{½}], is

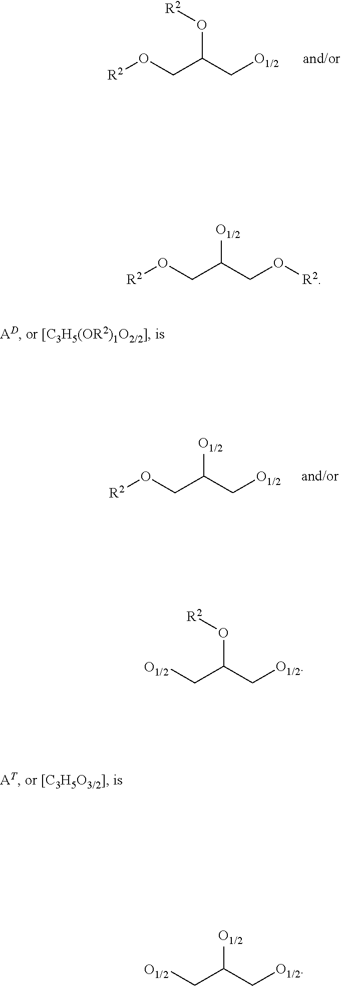

Of course, the proviso also applies that the structural unit (A) has at least three R¹ radicals.

Here, the structural unit (A) is composed of glycerol structural units selected from the group consisting of A^{M}, A^{D} and A^{T} such that each O_{1/2} forms an O together with another O_{1/2}. The O_{1/2} thus only occur in pairs.

It is more preferable that the structural unit (A) is a unit of the general formula (II),

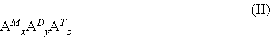

in which
x=0 to 10, preferably 2 to 3, especially 2;
y=0 to 10, preferably 0 to 5, especially 1 to 3;
z=0 to 3, preferably 0 to 1, especially 0;
   with the proviso that:
x+y+z=2 to 14, preferably 2 to 10, especially 3 to 6.

Here, x, y and z are the number of the corresponding units in a structural unit (A) and/or the number of the corresponding units per structural unit (A), given as a numerical average (arithmetic average) over all structural units (A) (e.g. in the composition according to the invention), preferably the latter, that is to say the number of corresponding units per structural unit (A) given as a numerical average (arithmetic average) over all structural units (A).

It is more preferable that the structural unit (A) is a unit of the general formula (III),

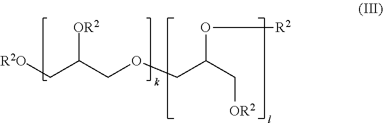

in which
k=0 to 10;
I=0 to 10;
   with the proviso that
k+1=2 to 14, preferably 2 to 10, especially 3 to 6.

Here, k and I are the number of the corresponding units in a structural unit (A) and/or the number of the corresponding units per structural unit (A), given as a numerical average (arithmetic average) over all structural units (A) (e.g. in the composition according to the invention), preferably the latter, that is to say the number of corresponding units per structural unit (A) given as a numerical average (arithmetic average) over all structural units (A). The units may be arranged in any manner.

The structural unit (A) of the urethane compound according to the invention contains at least three R¹ radicals. Any two chosen R¹ radicals may be identical or different. The R¹ radicals may thus all be identical, all different, or some of them may be identical/some of them different. Preferably, all R¹ radicals are identical.

The R¹ radicals may for example be linear or branched, cyclic or acyclic, aromatic or aliphatic, saturated or unsaturated and also—where possible—mixed forms thereof.

It is preferable that the R¹ radicals each independently are selected from C₃-C₃₉, preferably C₇-C₂₉, especially C₁₅-C₂₃ hydrocarbon radicals.

It is thus for example preferable that the R¹ radicals each independently are selected from C₄-C₃₉, C₅-C₃₉ or C₆-C₃₉ hydrocarbon radicals.

It is thus for example preferable that the R¹ radicals thus each independently are selected from the group consisting of C₃, C₄, C₅, C₆, C₇, C₈, C₉, C₁₀, C₁₁, C₁₂, C₁₃, C₁₄, C₁₅, C₁₆, C₁₇, C₁₈, C₁₈, C₁₉, C₂₀, C₂₁, C₂₂, C₂₃, C₂₄, C₂₅, C₂₆, C₂₇, C₂₈, C₂₉, C₃₀, C₃₁, C₃₂, C₃₃, C₃₄, C₃₅, C₃₆, C₃₇, C₃₈ and C₃₉ hydrocarbon radicals.

The R¹ radicals may contain heteroatoms excluding fluorine atoms. The heteroatoms are preferably selected from N, O, S. It is preferable that an R¹ radical does not contain more than 3 heteroatoms.

However, it is more preferable that the R¹ radicals each independently are selected from those hydrocarbon radicals not containing any heteroatoms. It is therefore preferable that the R¹ radicals each independently are selected from C₃-C₃₉, preferably C₇-C₂₉, especially C₁₅-C₂₃ hydrocarbon radicals not containing any heteroatoms. It is thus for example preferable that the R¹ radicals each independently are selected from C₄-C₃₉, C₅-C₃₉ or C₆-C₃₉ hydrocarbon radicals not containing any heteroatoms.

The R¹ radicals are preferably alkyl radicals which are optionally substituted with heteroatoms excluding fluorine atoms. However, it is more preferable that the R¹ radicals each independently are selected from those alkyl radicals not containing any heteroatoms. It is further preferable that the R¹ radicals each independently are selected from C₃-C₃₉, preferably C₇-C₂₉, especially C₁₅-C₂₃ alkyl radicals. It is therefore particularly preferable that the R¹ radicals each independently are selected from C₃-C₃₉, preferably C₇-C₂₉, especially C₁₅-C₂₃ alkyl radicals not containing any heteroatoms. It is thus for example preferable that the R¹ radicals each independently are selected from C₄-C₃₉, C₅-C₃₉ or C₆-C₃₉ alkyl radicals. It is thus for example further preferable that the R¹ radicals each independently are selected from C₄-C₃₉, C₅-C₃₉, C₆-C₃₉ alkyl radicals not containing any heteroatoms.

The R¹ radicals are for example those such as are present in fatty acids of the formula R¹-COOH, with the proviso that the fatty acids have 4 to 40 carbon atoms. The fatty acids of the formula R¹—COOH may be saturated or unsaturated; they are preferably saturated. Examples of suitable fatty acids of the formula R¹-COOH are butyric acid (butanoic acid), caproic acid (hexanoic acid), caprylic acid (octanoic acid), capric acid (decanoic acid), lauric acid (dodecanoic acid), myristic acid (tetradecanoic acid), palmitic acid (hexadecanoic acid), stearic acid (octadecanoic acid), arachidic acid (eicosanoic acid), behenic acid (docosanoic acid), lignoceric acid (tetracosanoic acid), palmitoleic acid ((Z)-9-hexadecenoic acid), oleic acid ((Z)-9-hexadecenoic acid), elaidic acid ((E)-9-octadecenoic acid), cis-vaccenic acid ((Z)-11-octadecenoic acid), linoleic acid ((9Z, 12Z)-9,12-octadecadienoic acid), α-linolenic acid ((9Z, 12Z, 15Z)-9, 12, 15-octadecatrienoic acid), γ-linolenic acid ((6Z,9Z, 12Z)-6,9, 12-octadecatrienoic acid), di-homo-gamma-linolenic acid ((8Z, 11Z, 14Z)-8, 11,14-eicosatrienoic acid), arachidonic acid ((5Z,8Z, 11Z, 14Z)-5,8, 11, 14-eicosatetraenoic acid), erucic acid ((Z)-13-docosenoic acid), nervonic acid ((Z)-15-tetracosenoic acid), ricinoleic acid, hydroxystearic acid and undecylenic acid, and also mixtures thereof, for example rapeseed oil acid, soya fatty acid, sunflower fatty acid, peanut fatty acid and tall oil fatty acid. Particularly preferably, the R¹ radicals are behenyl and/or stearyl radicals.

Sources of suitable fatty acids or fatty acid esters, in particular glycerides, can be vegetable or animal fats, oils or waxes. For example, it is possible to use: pork lard, beef tallow, goose fat, duck fat, chicken fat, horse fat, whale oil, fish oil, palm oil, olive oil, avocado oil, seed kernel oils, coconut oil, palm kernel oil, cocoa butter, cottonseed oil, pumpkinseed oil, maize kernel oil, sunflower oil, wheatgerm oil, grapeseed oil, sesame oil, linseed oil, soybean oil, peanut oil, lupin oil, rapeseed oil, mustard oil, castor oil, jatropha oil, walnut oil, jojoba oil, lecithin, for example based on soya, rapeseed or sunflowers, bone oil, neatsfoot oil, borage oil, lanolin, emu oil, deer tallow, marmot oil, mink oil, safflower oil, hemp oil, pumpkin oil, evening primrose oil, tall oil, and also carnauba wax, beeswax, candelilla wax, ouricury wax, sugarcane wax, retamo wax, caranday wax, raffia wax, esparto wax, alfalfa wax, bamboo wax, hemp wax, Douglas fir wax, cork wax, sisal wax, flax wax, cotton wax, dammar wax, tea wax, coffee wax, rice wax, oleander wax or wool wax.

The urethane compound may comprise further structural units besides the structural unit (A).

It is preferable that the urethane compound comprises at least one structural unit (B) having at least one biuret or isocyanurate structural unit.

The urethane compound preferably comprises either structural units (B) having at least one biuret structural unit or structural units (B) having at least one isocyanurate structural unit, especially the latter, that is to say structural units (B) having at least one isocyanurate structural unit. Preferably, the urethane compound accordingly therefore has either at least one biuret structural unit or at least one isocyanurate structural unit, especially at least one isocyanurate structural unit.

It is thus particularly preferable that the at least one structural unit (B) has at least one isocyanurate structural unit.

It is preferable that the at least one structural unit (B) each independently is selected from the group consisting of trivalent radicals of the formula (IV) and trivalent radicals of the formula (V),

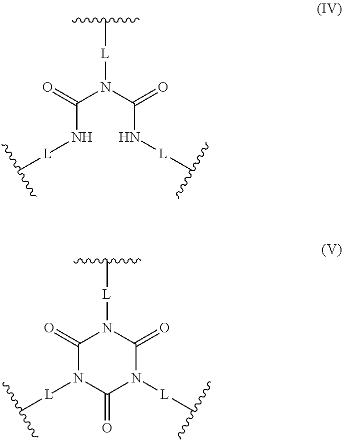

in which L is a divalent C₂-C₂₀ hydrocarbon radical which optionally contains heteroatoms excluding fluorine atoms.

It is particularly preferable that the at least one structural unit (B) each independently is selected from trivalent radicals of the formula (V).

Preferably, the divalent radicals L derive from diisocyanates of the formula L(NCO)₂, selected from toluene 2,4-/2,6-diisocyanate (TDI), diphenylmethane 4,4′-diisocyanate (MDI), naphthyl 1,5-diisocyanate (NDI), dicyclohexylmethane 4,4′-diisocyanate, 3-isocyanatomethyl-3,3,5-trimethylcyclohexyl isocyanate (isophorone diisocyanate=IPDI), butane 1,4-diisocyanate, hexane 1.6-diisocyanate (HDI), 2-methylpentane 1,5-diisocyanate, 2,2,4-trimethylhexane 1,6-diisocyanate (TMDI), dodecane 1,12-diisocyanate, cyclohexane 1,4-diisocyanate, 3,3′-dimethyldicyclohexylmethane 4,4′-diisocyanate, dicyclohexylpropane-(2,2)-4,4′-diisocyanate, 3-isocyanatomethyl-1-methyl-1-isocyanatocyclohexane (MCI), 2-methylcyclohexane 1,3-diisocyanate, especially from 3-isocyanatomethyl-3,3,5-trimethylcyclohexyl isocyanate (isophorone diisocyanate=IPDI).

It is moreover preferable that the urethane compound comprises at least one structural unit (C) selected from the group consisting of polysiloxane, polyether, poly(meth)acrylate, polyolefin, polybutadiene, polyester and polyamide structural units, preferably selected from the group consisting of polysiloxane, polybutadiene and polyether structural units, especially polysiloxane structural units.

It is preferable that the at least one structural unit (C) each independently is selected from structural units of the formula (VI):

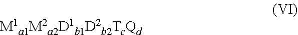

with

$${M}^{1} = [ {R}_{3}^{3} {SiO}_{1 / 2} ] ; \\ {M}^{2} = [ {R}^{4} {R}_{2}^{3} {SiO}_{1 / 2} ] ; \\ {D}^{1} = [ {R}_{2}^{3} {SiO}_{2 / 2} ] ; \\ {D}^{2} = [ {R}^{3} {R}^{4} {SiO}_{2 / 2} ] ; \\ T = [ {R}^{3} {SiO}_{3 / 2} ] ; \\ Q = [ {SiO}_{4 / 2} ] ;$$

a1=0 to 20, preferably 1 to 10, especially 2 to 5;
a2=0 to 20, preferably 1 to 10, especially 2 to 5;
b1=1 to 1000, preferably 5 to 500, especially 10 to 200;
b2=0 to 20, preferably 0 to 10, especially 0 to 5;
c=0 to 10, preferably 0 up to 5, especially 0;
d=0 to 50, preferably 0 to 10, especially 0;
   with the proviso that: a2+b2≥ 2:
   in which
R³ is a monovalent C₁-C₃₀ hydrocarbon radical which optionally contains heteroatoms excluding fluorine atoms;
R⁴ is a divalent C₁-C₃₀ hydrocarbon radical which optionally contains heteroatoms excluding fluorine atoms, and is bonded to the rest of the urethane compound, preferably to the structural unit (B) via a urethane or urea group.

Here, a1, a2, b1, b2, c and d are the number of the corresponding units in a structural unit (C) and/or the number of the corresponding units per structural unit (C), given as a numerical average over all structural units (C) (e.g. in the composition according to the invention), preferably the latter, that is to say the number of corresponding units per structural unit (C) given as a numerical average over all structural units (C).

It is preferable that R³ is selected from the group consisting of methyl, ethyl, propyl and phenyl, and in particular is methyl.

It is preferable that R⁴is —(CH₂)₆— and/or —(CH₂)₃—O—(CH₂)₂—, where —(CH₂)₃—O—(CH₂)₂— on the left-hand side in this representation is bonded to a silicon atom of the structural unit (C).

The urethane compound can therefore comprise at least one structural unit (B) and/or (C) in addition to at least one structural unit (A).

It is preferable that structural units (A) are linked with structural units (B) via urethane groups. It is particularly preferable that each structural unit (A) is linked with exactly one structural unit (B) via urethane groups. It is preferable here that the urethane group is bonded to a structural unit (B) via the nitrogen atom. The linkage between structural unit (B) and structural unit (A) can therefore be represented by formula (VII):

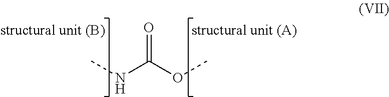

It is preferable that structural units (C) are linked with structural units (B) via urethane and/or urea groups. It is particularly preferable that each structural unit (C) is linked with two structural units (B) via urethane and/or urea groups. It is preferable here that the urethane group is bonded to a structural unit (B) via the nitrogen atom. The linkage between structural unit (B) and structural unit (C) can be represented by formula (VIII):

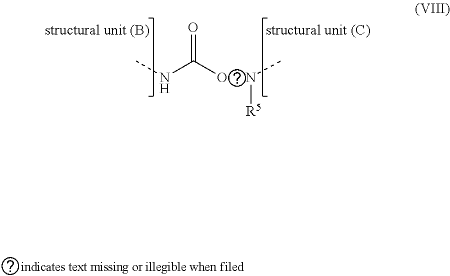

in which:
R⁵ each independently is H (hydrogen) or a substituted or unsubstituted C₁-C₃₀ alkyl radical which may be interrupted by heteroatoms, preferably each independently is an H or a substituted or unsubstituted C₁-C₃₀ alkyl radical, more preferably each independently is H or a C₁-C₅ alkyl radical, particularly preferably H.

The NH groups in the formulae (VII) and (VIII) may possibly react with further isocyanate groups to give allophanates and/or (further) biuret structures. Of course, this also includes the NH groups arising when R⁵ in formula (VIII) is H.

It is preferable that the structural units (C) are bonded exclusively to structural units (B), particularly preferably via urethane or urea groups.

It is moreover preferable that structural units (A) are bonded exclusively to structural units (B), particularly preferably via urethane groups.

It is preferable that the urethane compound has four structural units (A), two structural units (B) and one structural unit (C).

It is preferable that the urethane compound comprises at least one structural unit (D) which is (preferably reversibly) bonded to a structural unit (B), preferably via a urethane, amide, ester, urea or thiolurethane group.

A structural unit (D) preferably derives from a blocking agent for isocyanates which in turn is (preferably reversibly) bonded to isocyanate groups, which in turn are linked to the structural unit (B), or has been reacted with these isocyanate groups.

Blocking agents for isocyanates are known to those skilled in the art. Suitable blocking agents for isocyanates are for example acetoacetic acid, esters (e.g. malonic esters, especially diethyl malonate), pyrazoles (e.g. 3,5-dimethylpyrazole), oximes (e.g. butanone oxime), secondary of tertiary amines, lactams (e.g. ε-caprolactam), phenols (e.g. cardanol) and alcohols.

The structural unit (D) can also be derived from (meth)acrylates (e.g. glycerol dimethacrylate), acids, esters, epoxides or ammonium compounds (e.g. what are known as “quats”), or else further structural units which can bond to the textile covalently or via ionic interactions.

In summary, it can be stated that the urethane compound therefore optionally also comprises at least one structural unit (D) in addition to at least one structural unit (A) and optionally at least one structural unit (B) and/or (C). In this case, the structural units (B) differ from the structural units (A), the structural units (C) differ from the structural units (B) and (A), and the structural units (D) differ from the structural units (C), (B) and (A).

It is preferable that the urethane compound is free of fluorine atoms, in particular is free of halogen atoms.

it is preferable that the isocyanate number of the urethane compound is less than 1%, preferably less than 0.5%, especially less than 0.1%. The isocyanate number is preferably determined as described in the examples. it is particularly preferable that the urethane compound is essentially free of isocyanate groups.

It is further preferable that in the urethane compound
the number of structural units (A) is from 2 to 6, preferably from 3 to 5, especially is 4, and/or
the number of structural units (B) is from 1 to 3, preferably from 2 to 3, especially is 2, and/or
the number of structural units (C) is from 1 to 3, preferably from 1 to 2, especially is 1.

The structural units (A) may replace structural units which comprise perfluorinated or polyfluorinated alkyl radicals as are typically used in urethane compounds for hydrophobization for textile fabrics. The urethane compound is accordingly preferably suitable for hydrophobization for textile fabrics or of textile fabrics, especially textiles. The urethane compound according to the invention is thus preferably a urethane compound for hydrophobization for textile fabrics or of textile fabrics, especially textiles.

The urethane compound can be prepared by reaction of compounds comprising structural units (A), (B), (C) or (D). As compounds having at least one structural unit (B), preference is given here to using those compounds having at least one, preferably two or three isocyanate groups bonded to the structural unit (B). As compounds comprising at least one structural unit (A), (C) or (D), in turn those compounds are used which have at least one, two or three isocyanate-reactive groups bonded to the respective structural unit. Isocyanate-reactive groups are those groups that can react with isocyanates, such as for example amino, thiol, epoxy, carboxy or hydroxy groups.

The urethane compounds according to the invention can be prepared by prior art processes. However, preference is given to a process, wherein first an intermediate having the structural units (A) and (B) and optionally (D), but not (C), is prepared and then the intermediate is converted to give the urethane compounds according to the invention. This can reduce the risk of gelation. In the preparation of the urethane compound according to the invention, it has thus proved advantageous when one or more compounds having at least one structural unit (A) are first reacted with one or more compounds having at least one structural unit (B), and the intermediate obtained is subsequently reacted with one or more compounds having at least one structural unit (C) and/or with one or more compounds having at least one structural unit (D).

The invention therefore further provides a process for preparing one or more of the urethane compounds according to the invention, wherein first an intermediate having at least one structural unit (A) and at least one structural unit (B), but no structural unit (C), is prepared and then this intermediate is converted to give the urethane compound(s).

It is possible that the intermediate additionally has at least one structural unit (D).

Preferably, during the preparation of the intermediate (process step 1), a reaction takes place between a hydroxy group of a compound containing at least one structural unit (A) and an isocyanate group of a compound containing at least one structural unit (B). This results in the formation of a urethane group according to formula (VII). Preferably, half to three quarters of the isocyanate groups are converted.

Preferably, during the further conversion of the intermediate (process step 2), a reaction takes place between an isocyanate group of the intermediate and an isocyanate-reactive group of a compound containing at least one structural unit (C) and/or an isocyanate-reactive group of a compound containing at least one structural unit (D). This preferably results in the formation of a urethane or urea group according to formula (VIII).

Both process steps can be conducted as one-pot reaction, as process steps conducted separately in indirect or direct succession, or in a metering-controlled manner. The reaction can be conducted in a batchwise process, semibatchwise process or continuous process.

The process according to the invention can be effected in the presence or in the absence of a solvent. Suitable inert organic solvents used are preferably anhydrous aliphatic and alicyclic hydrocarbons, for example hexane, heptane, cyclohexane, and ethers, for example diethyl ether, ethylene glycol dimethyl ether, diethylene glycol dimethyl ether, diisopropyl ether, esters, for example ethyl acetate, n-propyl acetate, i-propyl acetate, n-butyl acetate, i-butyl acetate, amyl acetate, ketones, for example acetone, methyl ethyl ketone, methyl isobutyl ketone, and mixtures thereof.

It is preferable that the proportion by mass of all solvents together, based on the total mass of the reaction mixture, is 0% to 95%, preferably 10% to 85%, especially 30% to 70%.

Preference is given to conducting the process according to the invention at a temperature of 10 to 240° C., preferably of 30 to 200° C., especially of 50 to 175° C.

The process according to the invention can be conducted either under inert conditions (nitrogen, argon) or under an oxygen and/or air atmosphere, preferably under a nitrogen atmosphere.

The biuret—and/or isocyanurate-containing polyisocyanates preferably used in process step 1 are preferably trimers, tetramers, pentamers, hexamers and heptamers of diisocyanates, preference being given in turn to the diisocyanates of the formula L(NCO)2 listed above. The biuret—and/or isocyanurate-containing polyisocyanates may be used individually or else as mixtures. They may be identical or different polyisocyanates.

Catalysts may be used in order to accelerate the reaction in process step 1 and/or in process step 2. Suitable catalysts are known to those skilled in the art. It is preferable that the catalyst is selected from the group consisting of tin, bismuth, titanium, zinc, iron, aluminium and amine compounds, such as dibutyltin laurate, dioctyltin diketonate, dibutyltin dilaurate, dioctyltin dilaurate, dibutyltin diacetylacetonate, dibutyltin diacetate, dibutyltin dioctoate, dioctyltin diacetylacetonate, Borchi® catalysts, bismuth oxides, bismuth carboxylates, bismuth methanesulfonates, bismuth nitrate, bismuth chloride, triphenylbismuth, bismuth sulfide, titanates, e.g. titanium(IV) isopropoxide, iron(III) compounds, e.g. iron(III) acetylacetonate, aluminium triisopropoxide, aluminium tri-sec-butoxide and other aluminium alkoxides, aluminium acetylacetonate, zinc octoate, zinc acetylacetonate and zinc 2-ethylcaproate, tetraalkylammonium compounds, such as N,N,N-trimethyl-N-2-hydroxypropylammonium hydroxide, N,N,N-trimethyl-N-2-hydroxypropylammonium 2-ethylhexanoate or choline 2-ethylhexanoate. The catalyst is particularly preferably bismuth neodecanoate.

The catalyst is used preferably in concentrations of 5 to 5000 ppm. The amount in which the catalyst is used may considerably influence the composition of the end product For different catalysts it may therefore be advisable to select different use concentrations. For example, organotin catalysts are used preferably in concentrations of 5 to 150 ppm, and bismuth carboxylates preferably in concentrations of 300 to 2000 ppm. The concentration figures are based on the respective sum total of the co-reactants present, neglecting further unreactive constituents, for example solvents.

As a further component step for the preparation of the urethane compound according to the invention, a subsequent distillation/purification of the conversion products may be advantageous. It is preferable that the distillation/purification is effected at a temperature of 20 to 250° C., preferably of 40 to 180° C. and especially of 50 to 150° C. It is further preferable that the pressure here is from 0.0001 to 0.75 bar, preferably from 0.001 to 0.2 bar and especially from 0.01 to 0.1 bar. The distillation/workup may in particular be advantageous for removing solvents

The invention also further provides a composition containing one or more of the urethane compounds according to the invention, optionally obtainable by the process according to the invention.

It is preferable here that the structural unit (A) has at least 3, preferably 3 to 7, especially 3 to 5, R¹ radicals, taken as a numerical average over all structural units (A) present in the composition.

It is preferable that, taken as a numerical average over all structural units (A) present in the composition, at most 50%, preferably at most 40%, especially at most 25%, of all R² are selected from the group consisting of Z and H. The number of all R² selected from the group consisting of Z. and H divided by the number of all R² in the composition is in this case therefore at most 50%, preferably at most 40%, especially at most 25%, of all R².

It is preferable that, taken as a numerical average over all structural units (A) present in the composition, at least 50%, preferably at least 60%, especially at least 75%, of all R² are selected from the group consisting of R¹ and C(O)R¹, preferably C(O)R¹. The number of all R² selected from the group consisting of R¹, C(O)R¹, preferably C(O)R¹, divided by the number of all R² in the composition is in this case therefore at least 50%, preferably at least 60%, especially at least 75%.

It is further preferable that, taken as a numerical average over all structural units (A) present in the composition, at least 50%, preferably at least 60%, especially at least 75%, of all R² are selected from C(O)R^{1.} The number of all R² selected from C(O)R¹ divided by the number of all R² in the composition is therefore in this case at least 50%, preferably at least 60%, especially at least 75%.

It is particularly preferable that, taken as a numerical average over all structural units (A) present in the composition, at least 75% of all R² are selected from C(O)R^{1.} The number of all R² selected from C(O)R¹ divided by the number of all R² in the composition is therefore in this case particularly preferably at least 75%.

It is further preferable that the proportion by mass
of the structural units (A) is from 10% to 95%, preferably from 25% to 95%, especially from 35% to 85%, and/or
of the structural units (B) is from 0% to 50%, preferably from 5% to 30%, especially from 10% to 20%, and/or
of the structural units (C) is from 0% to 50%, preferably from 5% to 50%, especially from 5% to 25%,
   based in each case on the entirety of all urethane compounds in the composition.

It is further preferable that, taken as a numerical average over all urethane compounds in the composition,
the number of structural units (A) divided by the number of structural units (B) is from 1 to 5, preferably from 1.5 to 3.5, especially from 2.0 to 2.5, and/or
the number of structural units (B) divided by the number of structural units (C) is from 1 to 10, preferably from 1.5 to 5, especially from 1.6 to 2.2.

It is further preferable that, taken as a numerical average over all urethane compounds in the composition,
the number of structural units (A) is greater than 2.0, preferably from 3.0 to 10.0, especially from 3.4 to 8.0, and/or
the number of structural units (B) is from 1.0 to 3.0, preferably from 1.5 to 2.5, especially from 1.6 to 2.2, and/or
the number of structural units (C) is from 0.0 to 10.0, preferably from 0.5 to 1.5, especially from 1.0 to 1.2.

It is preferable that the isocyanate number of the composition is less than 1%, preferably less than 0.5%, especially less than 0.1%. The isocyanate number is preferably determined as described in the examples It is particularly preferable that the composition is essentially free of isocyanate groups.

Preference is given to using an aqueous dispersion for the finishing of textile fabrics. It is therefore preferable that the composition according to the invention is an aqueous dispersion.

It is preferable that the composition according to the invention contains additives selected from the group consisting of boosters, textile softeners, emulsifiers, solvents, perfumes, perfume carriers, dyes, viscosity regulators, defoamers, preservatives, active antimicrobial ingredients, germicides, fungicides, antioxidants, silicone oils, surfactants, builders, bleaches, bleach activators, enzymes, fluorescence agents, foam inhibitors, antiredeposition agents, optical brighteners, greying inhibitors, antishrink agents, anticrease agents, dye transfer inhibitors, corrosion inhibitors, antistats, bitter substances, ironing aids, repellency-imparting and impregnating agents, antiswell and antislip agents, neutral filler salts and UV absorbers. Substances of one class may possibly also fall under one of the other classes.

The use of so-called boosters can amplify the hydrophobizing action of the urethane compounds according to the invention. Suitable boosters are known to those skilled in the art. It is assumed that the boosters are capable of reacting in a crosslinking manner both with hydroxy and/or amino groups of the urethane compounds according to the invention and with the textile fabrics. Polycarbodiimides have proved to be particularly suitable boosters here. It is therefore preferable that the composition according to the invention contains at least one polycarbodiimide.

It is preferable that the composition according to the invention, based in each case on the total mass of the composition, contains the following constituents:
one or more of the urethane compounds according to the invention in a total proportion by mass of 10% to 100%, preferably of 15% to 80%, especially of 20% to 70%,
one or more additives in a total proportion by mass of 0% to 30%, preferably of 0% to 25%, especially of 0% to 20%,
water in such a proportion by mass that the sum total of the proportions by mass of all constituents is 100%.

In a preferred embodiment, the compositions according to the invention are aqueous dispersions, especially aqueous suspensions.

In an alternative preferred embodiment, the compositions according to the invention are concentrates which contain the urethane compounds according to the invention or the process products according to the invention in a proportion by a mass of 90% to 99.99%, based on the total mass of the composition. These concentrates are preferably not aqueous mixtures.

In a further alternative preferred embodiment, the compositions according to the invention are compound or dispersion concentrates which contain the urethane compounds according to the invention or the process products according to the invention in a proportion by mass of 40% to 90%, preferably of 50% to 80%, based on the total mass of the composition. Further constituents of these compositions are for example water and/or solvents, preferably selected from the group consisting of glycols, alcohols and alkyl ethers, and optionally one or more nonionic emulsifiers. Compound and dispersion concentrates are generally water-soluble or self-emulsifiable

Dilution of the concentrates or dispersion concentrates according to the invention with water makes it possible to obtain compositions which are particularly suitable for the treatment of textile fabrics.

The aqueous dispersions, especially aqueous suspensions, according to the invention contain the urethane compounds according to the invention or the process products according to the invention in a proportion by mass of 0.1% to 10%, preferably to 0.3% to 5%, especially 0.5% to 3%, based on the total mass of the aqueous dispersion or of the aqueous suspension.

Preferably, the compositions according to the invention are aqueous dispersions, especially aqueous suspensions, for the temporary or permanent finishing of textiles. However, the urethane compounds or compositions according to the invention may also be used to treat other sheet-like structures. The sheet-like structures can be stiff or flexible. Preference is given to sheet-like structures selected from the group consisting of wovens, loop-formed knits, loop-drawn knits, nonwovens, tissues, paper, cardboard, leather, hide and wood. The sheet-like structures are preferably produced from natural fibres or synthetic fibres or mixtures thereof. The fibres are preferably selected here from the group consisting of cotton-, polyester-, polyamide-, viscose-, cellulose- and lignin-based fibres.

The invention therefore also further provides a method for the water-repellent and/or oil-repellent impregnation of textile fabrics using one or more of the urethane compounds according to the invention, optionally obtainable by the process according to the invention, or using the composition according to the invention.

Methods for impregnating textile fabrics are known to those skilled in the art. The urethane compounds according to the invention and the compositions according to the invention can in principle be applied in the manner known to those skilled in the art.

The invention therefore also further provides a textile fabric obtainable by the method according to the invention for water-repellent and/or oil-repellent impregnation.

### DESCRIPTION OF THE FIGURE

FIG. 1: An example of a route for synthesis of a urethane compound according to the invention (in accordance with Example 12), in which, in a first step, an isocyanurate based on isophorone diisocyanate (compound having a structural unit (B)) is reacted with a hydroxy-functional polyglycerol ester (compound having a structural unit (A)) to give an intermediate bearing isocyanate groups, and this intermediate is reacted in a second step with an amino-functional polysiloxane (compound having a structural unit (C)) to give the urethane compound according to the invention.

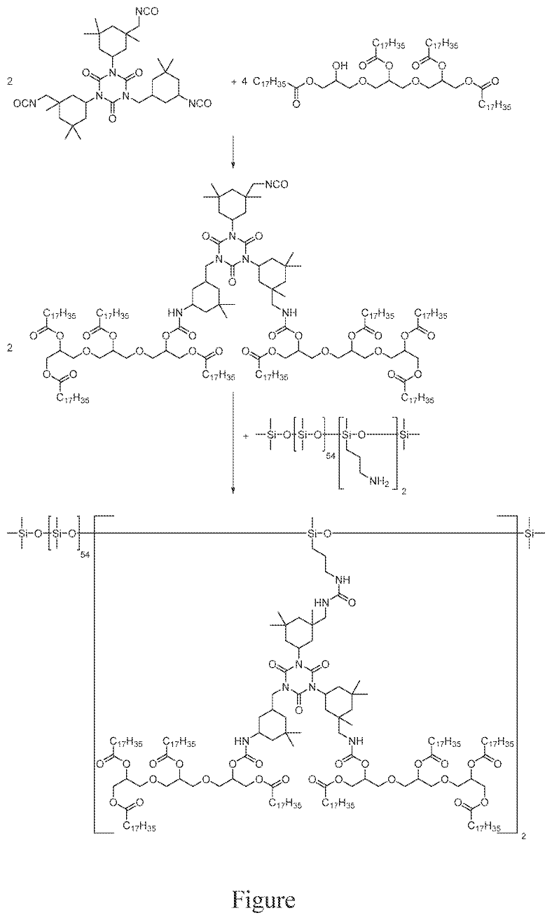

### EXAMPLES

Examples are cited hereinafter that serve solely to elucidate the execution of this invention to the person skilled in the art. They in no way whatsoever represent a restriction of the claimed subject-matter.

### General Methods

### Isocyanate Number (NCO Number, NCO Value)

The isocyanate number indicates the isocyanate content as a proportion by mass of the isocyanate groups in % and is determined in accordance with ISO 11909:2007. About 1.5 g of the polymer under investigation are weighed, accurately to 1 mg, into a 500 ml Erlenmeyer flask and dissolved in 25 ml of toluene, if necessary with gentle heating. After cooling to room temperature, 20 ml of a dibutylamine solution (approx. 0.2 mol/l in toluene) are added using a measuring pipette. The flask is sealed and the solution is left to react for 30 min. The solution is then diluted with 150 ml of ethanol and, after addition of a few drops of bromophenol blue solution, titrated with hydrochloric acid (0.1 mol/l) until the colour changes to yellow. If demixing can be observed during the titration, additional ethanol should be added.

### Gel Permeation Chromatography (GPC)

GPC measurements for determination of polydispersity (M_{w}/Mₙ), weight-average molar mass (Mw) and number-average molar mass (Mₙ) are conducted under the following measurement conditions:

Column combination SDV 1000/10 000 A (length in each case 25 cm, 3 cm precolumn), temperature 35° C., THF as mobile phase, flow rate 0.35 ml/min, sample concentration 10 g/l, RI detector, polymers according to the invention evaluated against polystyrene standard (162-2 520 000 g/mol).

### Determination of the Acid Number (AN)

The acid number is determined by a titration method in accordance with DIN EN ISO 2114. The unit for the reported AN is mg KOH/g of polymer.

### Hydroxyl Number (OH Number, OHN)

The OHN is determined in accordance with the standard method DGF C-V17a by acetylation of the alcohol function with an excess of acetic anhydride in pyridine and back-titration with KOH solution. The unit for the OHN is mg KOH/g of polymer.

### Materials

### Chemicals and Raw Materials

behenic acid (BEA): KLK Emmerich GmbH (AN=199)
behenyl alcohol: Lanette 22, BASF
CARSPRAY® 300: dicocodimethylammonium chloride in 2-propanol, Evonik Operations GmbH
ε-caprolactam: Sigma Aldrich
ethyl acetate: purity: 99.5% by weight, Sigma-Aldrich
glycerol: Bernd Kraft GmbH (OHN=1791)
NISSO PB G-3000: a,0)-hydroxy-functional polybutadiene (OHN=32), NIPPON SODA CO., LTD.
NX-2026: cardanol (OHN=188). Cardolite Corporation
polyglycerol-3 (PG-3): Spiga Nord S.p.A. (OHN=1110)
stearic acid (STA): KLK Emmerich GmbH (AN=199)
Tegomer® H-Si 2315: a hydroxy-functional organically modified polydimethylsiloxane (OHN=51.0), Evonik Operations GmbH
Tegomer® H-Si 2515: a hydroxy-functional organically modified polydimethylsiloxane (OHN=32.0), Evonik Operations GmbH
Tego@ SML 20: polyoxyethylene sorbitan fatty acid ester, Evonik Operations GmbH
TIB Kat 716 LA: bismuth neodecanoate, Bi content 15.0-16.5% by weight, TIB Chemicals AG
Span® 65: sorbitan tristearate (OHN=79), Sigma-Aldrich
Tomadok® 1-7: ethoxylated linear alcohols, Evonik Operations GmbH
Vestanat® T 1890/100. polyisocyanate based on isophorone diisocyanate with an NCO value of 17.2%, it contains isocyanurate structures and has an average NCO functionality between 3 and 4, Evonik Operations GmbH
Visiomer® GDMA: glycerol dimethacrylate, Evonik Operations GmbH
Voranol® 2000L: α,ω-hydroxy-functional propylene glycol (OHN=56), DOW
citric acid: Sigma Aldrich

### Fabric

polyester fabric (PES): weight per unit area 95 g/m2, thickness: 190 um, imbut GmbH (Zeulenrodaer Str. 42, 07973 Greiz)
polyester/cotton blended fabric (PES/Co): 65% by weight polyester and 35% by weight cotton, weight per unit area 170 g/m2, thickness: 410 um, WFK-Testgewebe GmbH (Christenfeld 10, 41379 Brüggen).

### Synthesis

### Component (A)

Tribehenyl Citrate 35.1 g of citric acid and 175 g of behenyl alcohol were stirred for 8 h at 140° C. while nitrogen was passed through the reaction mixture and water was distilled off. After cooling, a white solid having an AN of 10 was obtained. An OHN was not determined. An ideal molecular weight of 1104 g/mol for tribehenyl citrate was assumed for the further reaction.

### Glycerol Distearate

Under a nitrogen atmosphere, 56.4 g of glycerol and 338 g of stearic acid were heated to 240° C. and the water formed in the process was distilled off. After 5 h, the input of heat was stopped and the product was allowed to cool. The OHN was 88 and the AN was 1.7.

Polyglycerol ester

The reactants and weights used can be found in Table 1 Polyglycerol, catalyst and a carboxylic acid were initially charged and slowly heated to 240° ° C. under nitrogen. Water formed was carefully distilled off, with care being taken to ensure that no water flowed back and abruptly evaporated. Samples were taken at regular intervals and the acid number was determined. As soon as the acid number fell below 5, the reaction was ended.

TABLE 1
Synthesis of the polyglycerol esters; weights in g; OHN and AN in mg KOH/g.

| Component (A) for | | | | |
|---|---|---|---|---|
| synthesis of | Polyglycerol ^{[1]} | Carboxylic acid | Catalyst | OHN |
| Example 1 | 56.6 of PG-3 | 305 of BEA | — | 36 |
| | (OHN = 1110) | (0.80 eq, AN = 165) | | |
| Example 2 | 100 of PG-3 | 567 of BEA | — | 31 |
| | (OHN = 1100) | (0.85 eq, AN = 165) | | |
| Example 3 | 31.0 of PG-3 | 188 of BEA | — | 14 |
| | (OHN = 1110) | (0.90 eq, AN = 165) | | |
| Example 4 | 60.6 of PG-3 | 271 of STA | — | 48 |
| | (OHN = 1100) | (0.80 eq, AN = 199) | | |
| Examples 5, 9, 10, | 100 of PG-3 | 474 of STA | — | 34 |
| 11 | (OHN = 1110) | (0.85 eq, AN = 199) | | |
| Example 6 | 60.6 of PG-3 | 302 of STA | — | 30 |
| | (OHN = 1110) | (0.90 eq, AN = 199) | | |
| Example 7 | 100 of PG-4 | 456 of STA | — | 40 |
| | (OHN = 1067) | (0.85 eq, AN = 199) | | |
| Example 8 | 66.0 of PG-6 | 276 of STA | — | 33 |
| | (OHN = 977) | (0.85 eq, AN = 199) | | |
| Example 12 | 505 of PG-3 | 2537 of STA | 3.0 of TIB | 23 |
| | (OHN = 1110) | (0.90 eq, AN = 199) | KAT 717 LA | |
| Examples 13, 14 | 360 of PG-3 | 1757 of STA | 2.1 of TIB | 30 |
| | (OHN = 1110) | (0.88 eq, AN = 199) | KAT 717 LA | |
| Example 15 | 505 of PG-3 | 2537 of STA | 3.0 of TIB | 23 |
| | (OHN = 1110) | (0.90 eq, AN = 199) | KAT 717 LA | |
| Example 16 | 459 of PG-3 | 2284 of STA | — | 26 |
| | (OHN = 1100) | (0.90 eq, AN = 199) | | |
| Comparative | 160 of PG-3 | 230 of STA | 0.08 of calcium | 348 |
| example 4 | (OHN = 1100) | (0.26 eq, AN = 199) | hydroxide | |

^{[1]} set to 1.00 eq OH

### Urethane Compounds (Active Substances)

### Examples 1 to 8

The synthesis was conducted under nitrogen atmosphere in accordance with the following method and using the amounts of the raw materials indicated in Tables 2 and 3:

The isocyanurate Vestanat ® T 1890/100 (component (B)) with 17.3% NCO was initially charged, ethyl acetate (solvent) was added thereto and the temperature was raised to 60° C. 1000 ppm of the catalyst TIB Kat 716 LA was added to the solution. The waxy component (A) was then added (2 3 eq OH based on 3.5 eq NCO of component (B)), either as solid (examples 1 and 5) or as a liquid wax which had previously been melted at 80° C. (remaining examples). The mixture was refluxed for 5 h. If the theoretically expected amount of 65.7%+3% of all isocyanate groups had not yet reacted at this point, more component (A) was correspondingly metered in and the reaction refluxed further until the reaction mixture had achieved the desired NCO value (corresponding to a conversion of 65.7%±3% of all NCO groups). After the targeted NCO value had been reached, the component (C) Tegomer® H-Si 2515 (1.2 eq OH based on 3.5 eq NCO of component (B)) together with 500 ppm of the catalyst TIB Kat 716 LA were added. The reaction mixture was refluxed further until complete conversion of all NCO groups, in order ultimately to obtain a solution of the active substance which solidifies on cooling The weight-average molar mass (Mw) of the active substance obtained can be found in Table 2

TABLE 2
Examples 1 to 8, amounts reported in g, OHN in mg KOH/g, ratio
of eq OH in percent, weight-average molar mass (Mw) in kDa.

| Example | (A) | (B) | (C) | SOLVENT | Mw |
|---|---|---|---|---|---|
| 1 | 53.6 | 12.8 | 31.6 | 138 | 56 |
| | of PG-3, 80% BEA | | | | |
| | OHN = 36 | | | | |
| 2 | 376 | 77.4 | 191 | 968 | 102 |
| | of PG-3, 85% BEA | | | | |
| | OHN = 31 | | | | |
| 3 | 64.1 | 6.07 | 15.0 | 128 | 9.7 |
| | of PG-3, 90% BEA | | | | |
| | OHN = 14 | | | | |
| 4 | 49.9 | 15.8 | 39.1 | 157 | 220 |
| | of PG-3, 80% STA | | | | |
| | OHN = 48 | | | | |
| 5 | 68.1 | 15.3 | 37.9 | 182 | 57 |
| | of PG-3, 85% STA | | | | |
| | OHN = 34 | | | | |
| 6 | 64.5 | 12.8 | 31.6 | 109 | 44 |
| | of PG-3, 90% STA | | | | |
| | OHN = 30 | | | | |
| 7 | 55.3 | 14.6 | 36.1 | 159 | — |
| | of PG-4, 85% STA | | | | |
| | OHN = 40 | | | | |
| 8 | 59.3 | 12.8 | 31.6 | 154 | 143 |
| | of PG-6, 85% STA | | | | |
| | OHN = 33 | | | | |

### Examples 9 to 11

The synthesis of Examples 9 to 11 is conducted under nitrogen atmosphere in accordance with the following method and using the amounts of the raw materials listed in Table 3:

The isocyanurate Vestanat® T 1890/100 (component (B)) with 17.3% NCO was initially charged, ethyl acetate (solvent) was added thereto and the temperature was raised to 60° C. 1000 ppm of the catalyst TIB Kat 716 LA was added to the solution. Component (D) was added (0.5 eq OH or NH based on 3.5 eq NCO of component (B)), and the reaction was refluxed until the NCO number indicated complete conversion of component (D) (Examples 9 and 11) or the procedure was immediately continued with addition of component (A) (Example 10). PG-3, 85% STA (OHN=34, 1.8 eq OH based on 3.5 eq NCO of component (B)) was then added as component (A) as an 80° C. hot, liquid wax. The mixture was refluxed for 4 h to 5 h. If the theoretically expected amount of isocyanate had not yet reacted at this point, more component (A) was correspondingly metered in and the reaction refluxed further until the reaction mixture had achieved the desired NCO value. After the targeted NCO value had been reached (corresponding to a conversion of 65.7%±3% of all NCO groups of component (B)), Tegomer® H-Si 2515 as component (C) (1.2 eq OH based on 3.5 eq NCO of component (B)) together with 500 ppm of the catalyst TIB Kat 716 LA were added. The reaction mixture was refluxed further until complete conversion of all NCO groups, in order ultimately to obtain a solution of the active substance which solidifies on cooling. The weight-average molar mass (Mw) of the active substance obtained can be found in Table 3.

Table 3: Examples 1 to 9, amounts reported in g, weight-average molar mass (Mw) in kDa.

TABLE 3
Examples 1 to 9, amounts reported in g,
weight-average molar mass (M_{W}) in kDa.

| Example | (A) | (B) | (C) | (D) | SOLVENT | M_{W} |
|---|---|---|---|---|---|---|
| 9 | 46.2 | 12.8 | 31.6 | 2.24 of | 139 | 35 |
| | | | | Cardanol | | |
| | | | | NX-2026 | | |
| 10 | 46.2 | 12.8 | 31.6 | 0.85 of ε- | 137 | 158 |
| | | | | caprolactam | | |
| 11 | 46.2 | 12.8 | 31.6 | 1.71 of | 138 | — |
| | | | | Visiomer ® | | |
| | | | | GDMA | | |

### Examples 12 to 14

Examples 12, 13 and 14 are synthesized analogously to Examples 1 to 8, but using the components (C) listed in Table 4 instead of 1.2 eq of Tegomer® H-Si 2515.

Table 4: Examples 1 to 9, amounts reported in g, OHN in mg KOH/g, weight-average molar mass (Mw) in kDa; equivalents (eq) are based on the number of hydroxy or amine groups relative to 3.5 eq of isocyanate in component (B).

TABLE 4
Examples 1 to 9, amounts reported in g, OHN in mg KOH/g, weight-average
molar mass (Mw) in kDa; equivalents (eq) are based on the number of hydroxy
or amine groups relative to 3.5 eq of isocyanate in component (B).

| Example | (A) | (B) | (C) | SOLVENT | Mw |
|---|---|---|---|---|---|
| 12 | 85.6 | 12.8 | 37.0 (1.2 eq) | 135 | 118 |
| | of PG-3 90% | | of amino-functional | | |
| | STA | | polydimethylsiloxane, | | |
| | OHN = 23 | | average of 54 | | |
| | | | SiMe₂O units per | | |
| | | | chain | | |
| 13 | 65.6 | 12.8 | 19.8 (1.2 eq) of | 147 | 95.3 |
| | of PG-3 88% | | Tegomer ® H-Si 2315 | | |
| | STA | | | | |
| | OHN = 30 | | | | |
| 14 | 67.5 | 13.1 | 54.1 (2.0 eq) of | 202 | 20.7 |
| | of PG-3 88% | | Tegomer ® H-Si 2515 | | |
| | STA | | | | |
| | OHN = 30 | | | | |

### Example 15

α,107 -Hydroxy-functional polypropylene glycol (Voranol® 2000L) as component (C):

The synthesis was conducted under nitrogen atmosphere. 11.5 g of the isocyanurate Vestanat ® T 1890/100 (component (B)) with 17.3% NCO were initially charged. 157 g of ethyl acetate were added and the temperature was raised to 60° C. 1000 ppm of the catalyst TIB Kat 716 LA was added to the solution. 76.9 g of PG-3 90% STA (OHN=22.6, 2.3 eq OH based on 3.5 eq NCO) were then added as component (A). The mixture was refluxed for 7 h, an additional 500 ppm of TIB Kat 716 LA being added after 6 h. The NCO value indicates an isocyanate conversion of 63% after 7 h. Then, 16.3 g of Voranol® 2000L (OHN: 55.5, 1.2 eq OH based on 3.5 eq NCO of component (B)) and 500 ppm of the catalyst TIB Kat 716 LA were added at 60° C. The reaction mixture was refluxed for 3 h until complete conversion of all NCO groups, in order ultimately to obtain a cloudy mixture at 60° C. which solidified on cooling to room temperature.

### Example 16

### α,ω-Hydroxy-Functional Polybutadiene (NISSO PB G-3000) as Component (C)

The synthesis was conducted under nitrogen atmosphere: 8.99 g of the isocyanurate Vestanat & T 1890/100 (component (B)) with 17 3% NCO were initially charged. 126 g of ethyl acetate were added and the temperature was raised to 78° C. 1000 ppm of the catalyst TIB Kat 716 LA was added to the solution. 54.5 g of PG-3, 90% STA (OHN=26.0, 2.3 eq OH based on 3.5 eq NCO of component (B)) were then added as component (A). The mixture was refluxed for 5 h. The NCO value indicated an isocyanate conversion of 69% after 5 h. Then, 22.2 g of NISSO PB G-3000 (OHN: 32, 1.2 eq OH based on 3.5 eq NCO of component (B)) and 500 ppm of the catalyst TIB Kat 716 LA were added at 78° C. The reaction mixture was refluxed for a further 3 h until complete conversion of all NCO groups, in order ultimately to obtain a slightly cloudy solution of the active substance at 60° C.

### Comparative Example 1

Tribehenyl citrate as Component (A)

The synthesis was conducted under nitrogen atmosphere. 15.4 g of the isocyanurate Vestanat® T 1890/100 (component (B)) with 17.3% NCO were initially charged. 150 g of ethyl acetate were added and the temperature was raised to 60° C. 1000 ppm of the catalyst TIB Kat 716 LA was added to the solution. 46.0 g of tribehenyl citrate (2.3 eq OH based on 3.5 eq NCO of component (B)) were then added as component (A). The mixture was refluxed for 8 h. 38.1 g of Tegomer® H-Si 2515 (1.2 eq OH based on 3.5 eq NCO of component (B)) were then added as component (C) together with 500 ppm of the catalyst TIB Kat 716 LA. The reaction mixture was refluxed further for 11 h until complete conversion of all NCO groups, in order ultimately to obtain a solution of the active substance at 60° C. Production of a formulation using ultrasound, as described below, resulted in a gelated dispersion, and thus it was no longer suitable for application to the textile.

### Comparative Example 2

Sorbitan tristearate (Span® 65) as Component (A)

The synthesis was conducted under nitrogen atmosphere: 21.2 g of the isocyanurate Vestanat ® T 1890/100 (component (B)) with 17.3% NCO were initially charged. 172 g of ethyl acetate were added and the temperature was raised to 60° C. 1000 ppm of the catalyst TIB Kat 716 LA was added to the solution. 40.8 g of Span® 65 (OHN=79, sorbitan stearate ester from Sigma Aldrich, 2.3 eq OH based on 3.5 eq NCO of component (B)) were then added as component (A). The mixture was refluxed for 4.5 h. The NCO value indicated an isocyanate conversion of 68% after this time. 52.6 g of Tegomer® H-Si 2515 (1.2 eq OH based on 3 5 eq NCO of component (B)) were then added as component (C) together with 500 ppm of the catalyst TIB Kat 716 LA. The reaction mixture was refluxed further for 3 h until complete conversion of all NCO groups. A jelly-like mass was obtained which could not be formulated into a suitable dispersion.

### Comparative Example 3

Monoglycerol distearate as Component (A)

The synthesis was conducted under nitrogen atmosphere. 22.8 g of the isocyanurate Vestanat ® T 1890/100 (component (B)) with 17.3% NCO were initially charged. 178 g of ethyl acetate were added and the temperature was raised to 60° C. 1000 ppm of the catalyst TIB Kat 716 LA was added to the solution. 39.4 g of glycerol distearate (OHN=88, 2.3 eq OH based on 3.5 eq NCO of component (B)) were then added as component (A). The mixture was refluxed for 5 h The NCO value indicated an isocyanate conversion of 55% after this time. A further 7.98 g of glycerol distearate were then metered in and the mixture was refluxed for a further 2 h. The NCO value indicated an isocyanate conversion of 64% after this time. 56.5 g of Tegomer® H-Si 2515 (1.2 eq OH based on 3.5 eq NCO of component (B)) were then added as component (C) together with 500 ppm of the catalyst TIB Kat 716 LA. The reaction mixture was refluxed for a further 4 h until complete conversion of all NCO groups, in order ultimately to obtain a clear, pale yellow solution of the active substance at 60° C. On cooling to room temperature a precipitate formed and a suspension was obtained. The production of a formulation, as described below, afforded a thick paste which could be diluted with water only with difficulty. The application to the textile fabric was therefore very difficult and not possible industrially.

### Comparative Example 4

Low-Esterified polyglycerol Component as Component (A)

The synthesis was conducted under nitrogen atmosphere. 34.0 g of the isocyanurate Vestanat® T 1890/100 (component (B) with 17.3% NCO were initially charged. 199 g of ethyl acetate were added and the temperature was raised to 60° C. 1000 ppm of the catalyst TIB Kat 716 LA was added to the solution. 14.8 g of polyglycerol stearate (OHN=348, 2.3 eq OH based on 3.5 eq NCO of component (B)) were then added as component (A). The mixture was refluxed for 5 h. The NCO value indicated an isocyanate conversion of 63% after this time. A few clumps of gel formed on the inner edge of the flask. 84.2 g of Tegomer@ H-Si 2515 (1.2 eq OH based on 3.5 eq NCO of component (B) were then added as component (C) together with 500 ppm of the catalyst TIB Kat 716 LA. After 27 min under reflux conditions, the reaction mixture had completely gelated and thus further formulation was no longer possible.

### Performance Testing

### Production of the Formulations

The initial charge (50 g of active substance and 75 g of organic solvent (ethyl acetate) and additional component (1.33 g of Carspray® 300, 3 g of Tomadoi® 1-7, 1.5 g of TEGO® SML 20 and 128 g of water) were weighed out separately. The initial charge and the additional component were heated at 60° C. in a drying cabinet until they were clear and had low viscosity. The additional component was then added to the initial charge and the mixture was stirred. During the stirring, the mixture was sonicated with ultrasound (Bandelin Sonopuls HD 3400 ultrasonic homogenizer; maximum power, approx. 3 min). The solvent was then distilled off on a rotary evaporator (bath temperature: 60 to 70° C.) until a white, homogeneous formulation was obtained which could be diluted with water.

Alternatively to this method, the active substances may also be emulsified using a slot homogenizer or another dispersing tool in a manner known to those skilled in the art.

### Application of the Active Substances by the Padding Method (HVF Model, Mathis AG)

To test the respective formulations, these were applied to polyester fabrics (PES) and polyester/cotton blended fabrics (PES/Co) by way of a liquor containing the corresponding formulation in diluted form, squeezed off to a liquor pick up of approx. 40% to 90% by weight (based on the dry weight of the textile before application) and dried. The values employed for pressure and speed can be found in Table 5. Padding application took place at room temperature.

TABLE 5
Pressures and roll speeds used in the padding method.

| Name | Pressure [bar] | Speed [m/min] |
|---|---|---|
| Polyester fabric (PES) | 2.4 | 2 |
| PES/Co blended fabric | 3 | 2 |

Alternatively, the active substances can also be applied by an exhaust method or by a spraying process.

Drying Method (LTE Lab Dryer, Mathis AG, Ventilator Speed 1800 rpm):

The fabrics were dried at 105° ° C.(plus dwell time, i e. the heating time of the textile fabric) for 2 min and then heated at 150 to 180° ° C.(without dwell time) for 0.5 to 3 min in order to fix the finish.

### Testing of the Finish

### Spray Test in Accordance With AATCC-22

To evaluate the water repellency, the treated test fabrics were each clamped in a round frame (diameter 155±5 mm) and sprinkled. Care was taken to ensure that the fabrics were neither slack nor too taut A funnel with water outlet was suspended 15 cm above the material, the latter being angled at 45°. 250 ml of demineralized water were added to the funnel and the material was sprinkled therewith. At the end of the flow time, the appearance of the adherent water was assessed visually, as presented in Table 6.

TABLE 6
Spray test evaluation scale

| | |
|---|---|
| Score of 100 | no wetting of the surface |
| Score of 90 | very minor wetting of the surface |
| Score of 80 | wetting of the surface at the droplet impact sites |
| Score of 70 | partial wetting of the entire surface |
| Score of 50 | total wetting of the entire surface |
| Score of 0 | total wetting of the upper and lower surface of the test piece |

For better differentiation, additional intermediate grades were introduced as shown in Table 7.

TABLE 7
Expanded spray test evaluation scale

| | |
|---|---|
| Score of 95 | Better than 90, worse than 100 |
| Score of 85 | Better than 80, worse than 90 |
| Score of 75 | Better than 70, worse than 80 |

Water Absorption:

The water absorption indicates how much water a textile absorbs when it is sprinkled. This property is especially important for outdoor textiles in particular. The value for water absorption was determined gravimetrically after the spray test and reported in %. It indicates the relative increase in weight of the textile as a result of the sprinkling in the spray test.

### Wash Test

The washing resistance was determined in accordance with AATCC Monograph 6-2016, Table I & IIC and Monograph M7 by washing the textile fabrics in a washing machine (SDL Atlas Vortex M6). For this, an AATCC 1993 standard detergent without optical brightener was used. In addition, cotton fabrics were added to the wash as ballast in order to ultimately achieve a washing load of 2.7 kg. Programme: Standard “permanent press—hot” wash (4° C.+/−4° C.), 66 g of detergent, wash duration: 38 min.

### Drying

The textile fabrics were dried with a drier (SDL Atlas Vortex M6D). Programme: “Automatic Permanent Press/Knits cycle—Less Dry”, duration of the drying programme: 1 h 45 min.

### Results of the Performance Testing

TABLE 8
Results of the spray tests and water absorption for polyester
at various concentrations. The formulations were diluted
to the indicated liquor concentration and then applied
by the padding method. The materials were then dried for
2 min at 105° C. and fixed for 1 min at 180° C.

| | | Spray test score | | | Water absorption | | |
|---|---|---|---|---|---|---|---|
| | | without (0x) and | | | without (0x) and | | |
| | Liquor | after washing | | | after washing | | |
| Component | concen- | 1x and 10x | | | 1x and 10x | | |
| (A) | tration | 0x | 1x | 10x | 0x | 1x | 10x |
| Control | 0.00% | 0 | 0 | 0 | 33.6% | 21.4% | 26.0% |
| Example 1 | 0.80% | 95 | 90 | 70 | 1.0% | 2.2% | 5.4% |
| Example 2 | 0.80% | 85 | 85 | 70 | 2.4% | 2.4% | 5.3% |
| Example 3 | 0.80% | 70 | 75 | — | 5.0% | 3.9% | — |
| Example 4 | 0.80% | 75 | 75 | — | 4.3% | 4.3% | — |
| Example 5 | 0.80% | 85 | 90 | 90 | 2.3% | 1.5% | 1.9% |
| Example 7 | 0.80% | 85 | — | — | 3.1% | — | — |
| Example 8 | 0.80% | 85 | — | — | 3.7% | — | — |
| Example 9 | 0.80% | 70 | — | — | 6.4% | — | — |
| Example 10 | 0.80% | 80 | 85 | 70 | 3.3% | 2.6% | 5.1% |
| Example 11 | 0.80% | 70 | — | — | 6.3% | — | — |
| Example 12 | 0.80% | 85 | — | — | 3.0% | — | — |
| Example 13 | 0.80% | 80 | — | — | 4.2% | — | — |
| Comparative | 0.80% | 50 | 25 | 25 | 8.5% | 10.0% | 12.0% |
| example 3 | | | | | | | |
| Example 1 | 1.60% | 80 | 90 | 50 | 3.6% | 2.2% | 6.6% |
| Comparative | 1.60% | 25 | 25 | 25 | 11.2% | 10.5% | 14.1% |
| example 3 | | | | | | | |

Table 8 shows that, in the case of the PES fabric, the examples according to the invention are better than the comparative example both in the spray test and in terms of water absorption. This can also be observed after the washing. This property is independent of the concentration.

TABLE 9
Results of the spray tests and water for PES/Co blended
fabrics at various concentrations. The formulations were
diluted to the indicated liquor concentration and then
applied by the padding method. The materials were then
dried for 2 min at 105° C. and fixed for 1 min at 180° C.

| | Liquor | Spray test | Water |
|---|---|---|---|
| Component (A) | concentration | score | absorption |
| Control | 0.00% | 0 | 42.9% |
| Example 1 | 0.80% | 85 | 3.8% |
| Example 2 | 0.80% | 80 | 4.5% |
| Example 3 | 0.80% | 50 | 12.9% |
| Example 4 | 0.80% | 50 | 13.7% |
| Example 5 | 0.80% | 70 | 7.7% |
| Example 10 | 0.80% | 75 | 6.1% |
| Comparative | 0.80% | 0 | 27.3% |
| example 3 | | | |
| Example 1 | 1.60% | 85 | 3.0% |
| Example 2 | 1.60% | 85 | 3.2% |
| Example 3 | 1.60% | 60 | 10.7% |
| Example 4 | 1.60% | 70 | 8.4% |
| Example 5 | 1.60% | 80 | 4.4% |
| Example 10 | 1.60% | 80 | 4.3% |
| Comparative | 1.60% | 0 | 25.9% |
| example 3 | | | |

Table 9 shows that, in the case of the PES/Co blended fabric as well, the examples according to the invention are better than the comparative example both in the spray test and in terms of water absorption. This property is independent of the concentration.

1. A urethane compound containing at least one structural unit (A), wherein the structural unit (A) is a polyglycerol structural unit having at least three R¹ radicals which are each independently selected from C₃-C₃₉ hydrocarbon radicals optionally containing heteroatoms excluding fluorine atoms.

2. The urethane compound according to claim 1, wherein the structural unit (A) is bonded to the rest of the urethane compound via at least one urethane group.

3. The urethane compound according to claim 1, wherein the structural unit (A) comprises at least two glycerol structural units, the glycerol structural units being selected from the group consisting of AM^{M}=[C₃H₅(OR²)₂O_{1/2}], A^{D}=[C₃H₅(OR²)₁O_{2/2}] and A^{T}=[C₃H₅O_{3/2}], in which R² each independently is selected from the group consisting of Z, H, R¹, and C(O)R¹, in which Z is a covalent bond to the rest of the urethane compound.

4. The urethane compound according to claim 3, wherein exactly one R² of the structural unit (A) is Z and all other R² are selected from the group consisting of H, R¹, and C(O)R¹.

5. The urethane compound according to claim 4, wherein exactly one R² of the structural unit (A) is Z and all other R² are C(O)R¹, in which all R¹ each independently are selected from C₄-C₃₉ hydrocarbon radicals.

6. The urethane compound according to claim 1, wherein it comprises at least one structural unit (B) having at least one biuret or isocyanurate structural unit.

7. The urethane compound according to claim 6, wherein the at least one structural unit (B) has at least one isocyanurate structural unit.

8. The urethane compound according to claim 6, wherein the at least one structural unit (B) each independently is selected from the group consisting of trivalent radicals of the formula (IV) and trivalent radicals of the formula (V). 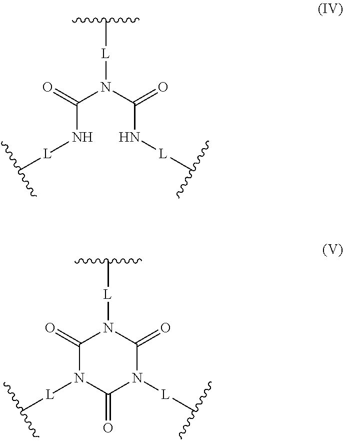
in which L is a divalent C₂-C₂₀ hydrocarbon radical which optionally contains heteroatoms excluding fluorine atoms.

9. The urethane compound according to claim 1, wherein it comprises at least one structural unit (C) selected from the group consisting of polysiloxane, polyether, poly(meth)acrylate, polyolefin, polydiene, polyester, and polyamide structural units.

10. The urethane compound according to claim 9, wherein the at least one structural unit (C) each independently is selected from structural units of the formula (VI): 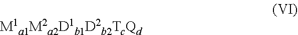
with
$${M}^{1} = [ {R}_{3}^{3} {SiO}_{1 / 2} ] ; \\ {M}^{2} = [ {R}^{4} {R}_{2}^{3} {SiO}_{1 / 2} ] ; \\ {D}^{1} = [ {R}_{2}^{3} {SiO}_{2 / 2} ] ; \\ {D}^{2} = [ {R}^{3} {R}^{4} {SiO}_{2 / 2} ] ; \\ T = [ {R}^{3} {SiO}_{3 / 2} ] ; \\ Q = [ {SiO}_{4 / 2} ] ; \\ a 1 = 0 to 20 , \\ a 2 = 0 to 20 , \\ b 1 = 1 to 1000 , \\ b 2 = 0 to 20 , \\ c = 0 to 10 , \\ d = 0 to 50 ,$$
with the proviso that: a2+b2 ≥ 2;
in which
R³ is a monovalent C₁-C₃₀ hydrocarbon radical which optionally contains heteroatoms excluding fluorine atoms;
R⁴ is a divalent C₁-C₃₀ hydrocarbon radical which optionally contains heteroatoms excluding fluorine atoms, and is bonded to the rest of the urethane compound via a urethane or urea group.

11. The urethane compound according to claim 1, which is free of fluorine atoms.

12. A process for preparing one or more urethane compounds according to claim 1, comprising:
first preparing an intermediate having at least one structural unit (A) and at least one structural unit (B), wherein the at least one structural unit (B) comprises at least one biuret or isocyanurate structural unit. but no structural unit (C), wherein structural unit (C) is selected from the group consisting of polysiloxane, polyether. poly(meth)acrylate, polyolefin. polydiene, polyester, and polyamide structural units, and converting the intermediate to give the urethane compound(s).

13. A composition containing or consisting of at least one urethane compound according to claim 1.

14. The composition according to claim 13, wherein the structural unit (A) has at least 3 R¹ radicals, taken as a numerical average over all structural units (A) present in the composition.

15. The composition according to claim 13, which is an aqueous dispersion.

16. A method for the water-repellent and/or oil-repellent impregnation of textile fabrics using the composition according to claim 13.

17. The textile fabrics obtainable by the method according to claim 16.

18. The urethane compound according to claim 1. wherein the structural unit (A) is bonded to the rest of the urethane compound via one or two urethane groups.

19. The urethane compound according to Claim I. wherein the structural unit (A) is bonded to the rest of the urethane compound via exactly one urethane group
